(19) United States
(12) Patent Application Publication
(10) Pub. No.: US 2003/0103321 A1
(43) Pub. Date: Jun. 5, 2003

(54) Ethylene glycol mixture, al-electrolyte capacitor with the ethylene glycol mixture and use of the ethylene glycol mixture

(76) Inventor: Thomas Ebel, Campo (DE)

Correspondence Address: SCHIFF HARDIN & WAITE, 6600 SEARS TOWER, 233 S WACKER DR, CHICAGO, IL, 60606-6473, US

(21) Appl. No.: 10/276,167

(22) PCT Filed: Mar. 9, 2001
(86) PCT No.: PCT/DE01/00909

(30) Foreign Application Priority Data
May 12, 2000 (DE) 100-23-361.9

(51) Int. Cl. H01G 9/04

(52) U.S. Cl. 361/508

(57) ABSTRACT

The invention is directed to an ethylene glycol mixture with:

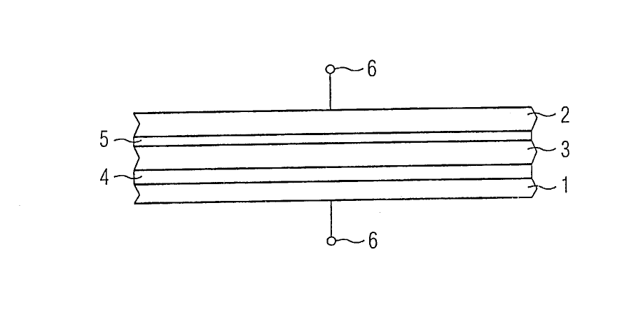

a) 20-70 weight percent ethylene glycol

b) 1-10 weight percent ammonium pentaborate

c) 1-10 weight percent mannitol

d) 0-1.0 weight percent 4-nitro-benzoic acid

e) 0-0.5 weight percent ammonium hypophosphite

f) 3-35 weight percent diethylene glycol monobutyl ether

g) 2-10 weight percent of a mixture of dimeric and trimeric acids.

The water content of the electrolyte can be reduced by employing a mixture of dimeric and trimeric acids. the residual current is thereby reduced, and the durability of the capacitor is improved. The invention is also directed to an Al electrolytic capacitor with the inventive ethylene glycol mixture as electrolyte. over and above this, the invention is directed to the employment of the ethylene glycol mixture

The invention is directed to an ethylene glycol mixture that also comprises ammonium pentaborate in addition to ethylene glycol. The invention is also directed to an aluminum electrolytic capacitor with the ethylene glycol mixture as electrolyte. Over and above this, the invention is directed to the use of the ethylene glycol mixture.

Ethylene glycol mixtures of the species initially cited are known that contain ammonium pentaborate (NH₄B₅O₈×4 H₂O). The ammonium pentaborate forms ions in the ethylene glycol, so that the known ethylene glycol mixtures can be employed as electrolyte in Al electrolytic capacitors.

Aluminum electrolytic capacitors are constructed as a layer stack composed of a cathode foil, which, for example, can be a thin, roughened Al foil having a thickness between 20 and 50 μm, and an anode foil, which, for example, can be an approximately 100 μm thick, roughened Al foil and which comprises a dielectrically acting oxide layer that is applied directly on the foil by means of electrochemical processes. The cathode foil also comprises a thin, approximately 1.5-3 nm thick oxide layer. The layer stack is usually present in the form of a winding wound on an arbor that is built into an aluminum pot.

A single-ply or multi-ply paper layer that is impregnated with the operating electrolyte is situated between the foils. This operating electrolyte represents the actual cathode. The foils are usually implemented as winding wound on a winding arbor.

Known ethylene glycol mixtures have the disadvantage that, with up to 40 weight percent, they contain a very high proportion of water. The oxide layers on the anode or, respectively, cathode foil are attacked by the water. The cathode foil is uncovered due to the attack on the cathode oxide and hydrogen gas arises. The service life of the capacitor is limited as a result thereof.

The attack on the oxide of the anode foil results therein that existing cracks in the oxide are enlarged, as a result whereof the residual current flowing in the capacitor becomes greater. An increased residual current leads to an intensified formation of gas due to electrolysis of the operating electrolyte. An increase of the residual current is undesirable for this reason.

Further, the known ethylene glycol mixtures have the disadvantage that the relatively high water content also involves higher conductivities. The known electrolytic capacitors that employ the known ethylene glycol mixtures as electrolyte therefore have the disadvantage of a low sparking voltage. The known electrolytic capacitors are therefore not suited for operation given a voltage of more than 500 Volts.

It is therefore a goal of the present invention to specify an ethylene glycol mixture that is suited as electrolyte for an Al electrolytic capacitor and that comprises a low water content as well as a high sparking voltage.

This goal is inventively achieved by an ethylene glycol mixture according to claim 1. Advantageous developments of the invention, an aluminum electrolytic capacitor with the inventive ethylene glycol mixture and an employment of the invention can be derived from the further claims.

The invention specifies an ethylene glycol mixture having:

a) 20-70 weight percent ethylene glycol

b) 1-10 weight percent ammonium pentaborate

c) 1-10 weight percent mannitol

d) 0-1.0 weight percent 4-nitro-benzoic acid

e) 0-0.5 weight percent ammonium hypophosphite

f) 3-35 weight percent diethylene glycol monobutyl ether

g) 2-10 weight percent of a mixture of dimeric and trimeric acids.

In addition to these essential constituents, the inventive ethylene glycol mixture can also contain slight quantities of other standard constituents that do not deteriorate the desired properties of the mixture.

The inventive ethylene glycol mixture has the advantage that is comprises a low water content. The water content in the ethylene glycol mixture can be reduced because the dimeric and trimeric acids contained in the ethylene glycol mixture comprise long-chain carboxylic acids with a good electrical conductivity. The conductivity of the ethylene glycol mixture is therefore not deteriorated due to the reduced water content.

In addition to the water content, the presence of long-chain carboxylic acids is essential for the electrical conductivity of the ethylene glycol mixture. Due to the good electrical conductivity, the boron ion content in the inventive ethylene glycol mixture can also be reduced without deteriorating the conductivity of the ethylene glycol mixture. Further, the long-chain carboxylic acids exhibit the advantage of a high sparking voltage.

Over and above this an ethylene glycol mixture is especially advantageous that contains

a) 50-60 weight percent ethylene glycol

b) 2-4.5 weight percent ammonium pentaborate

c) 1-4 weight percent mannitol

d) 0.2-0.7 weight percent 4-nitro-benzoic acid

e) 0-0.2 weight percent ammonium hypophosphite

f) 15-22 weight percent diethylene glycol monobutyl ether

g) 3-9 weight percent of a mixture of dimeric and trimeric acids.

In addition to these essential constituents, this ethylene glycol mixture can also contain slight quantities of other standard constituents that do not deteriorate the desired properties of the mixture. In experiments, it has proven especially suited for employment in an aluminum electrolytic capacitor.

In an especially advantageous embodiment of the invention, the mixture of dimeric and trimeric acids can comprise dimeric or trimeric acids that are selected from the following list of CAS numbers: 61788-89-4, 68783-41-5, 68937-90-6.

These dimeric and trimeric acids are offered by Henkel Corporation Chemicals Group under the product names EMPOL®. These are thereby viscous liquids that are manufactured by oligomerization of C₁₈ acids. Although they represent a mixture of dibasic, tribasic and monobasic acids in reality, idealized structure formulas can be recited for the dimeric and trimeric acids. The dimeric acids contain small quantities of intermediate esters, whereas the trimeric acids contains anhydrides.

The dimeric acid as a C₃₆-aliphatic, dibasic acid. Its structure is composed of a long-chain bi-carboxylic acid with two alkyl side-chains. The structure contains at least one ethylene bond and a further bond that results from the polymerization of the two unsaturated acid molecules that form the dimeric acid. A plurality of connection possibilities between the originally present acid chains are thereby known.

The trimeric acid is a C₅₄ long-chain tri-carboxylic acid. A possible structure of the trimeric acid is similar to that of a dimeric acid; however, it is more complex because of an additional plurality of 18 carbon atoms. The trimeric acid comprises three or more alkyl side-chains as well as at least one ethylenic bond location.

The invention also recites an Al electrolytic capacitor wherein the electrolyte is the inventive ethylene glycol mixture. The capacitor comprises a layer stack with an anode layer and a cathode layer. A parting layer saturated with the electrolyte is arranged between the anode layer and the cathode layer. The anode layer and the cathode layer respectively comprise an oxide layer at their sides facing toward the parting layer. The anode layer and the cathode layer are composed of aluminum, whereas the oxide layers are composed of aluminum oxide.

The water content of a known ethylene glycol mixture can be reduced from 15% to 2.6% with said dimeric acids and trimeric acids. Due to the low water content, the oxide layers of the capacitor are not as greatly attacked. On the one hand, this leads thereto that the residual current and, thus, the gas formation in the capacitor are reduced. On the other hand, the attack on the oxide of the cathode layer or, respectively, on the cathode layer itself is thereby also reduced, which extends the service life of the capacitor.

Due to the long-chain carboxylic acids (which exhibit a good electrical conductivity) present in the ethylene glycol mixture, a part of the boron ions present in the known ethylene glycol mixtures can be replaced by the dimeric and trimeric acids without having a deterioration of the electrical conductivity of the electrolyte occurring. As a result thereof, the electrostatic serial resistance (ESR) of the capacitor does not increase given employment of the inventive ethylene glycol mixture compared to a known ethylene glycol mixture.

An increase of the sparking voltage from 620 Volts to 680 Volts was observed given employment of the dimeric and trimeric acids supplied by the Henkel company.

Further, the invention specifies the employment of the ethylene glycol mixture as electrolyte an in Al electrolytic capacitor for voltages between 500 and 600 Volts. Due to the high dielectric strength, the inventive ethylene glycol mixture has the advantage that it is suitable as electrolyte for an Al capacitor for voltages up to 600 Volts.

The invention is explained in greater detail below on the basis of an exemplary embodiment and the appertaining FIGURE.

The FIGURE shows the layer stack of an inventive aluminum electrolytic capacitor in a schematic crossection.

The layer stack of the inventive electrolytic capacitor is composed of an anode layer 1 that comprises a first oxide layer 4 at its upper side. The anode layer 1 is an aluminum foil having a thickness of approximately 50-120 μm. The first oxide layer 4 is composed of aluminum oxide and comprises a thickness between 1 and 10 μm.

A parting layer 3 is arranged over the first oxide layer 4. The parting layer 3 has a thickness between 30 and 200 μm and is preferably composed of paper. A cathode layer 2 is arranged over the parting layer 3, said cathode layer 2 comprising a second oxide layer 5 it its side facing toward the parting layer 3. The cathode layer 2 is composed of aluminum and comprises a thickness between 20 and 60 μm. The second oxide layer is composed of aluminum oxide and comprises a thickness between 1.5 and 3 nm. The second oxide layer 5 in this example is an oxide layer of the cathode layer 2 generated by calcining. The anode layer 1 and the cathode layer 2 are respectively electrically conductively connected to a capacitor terminal 6.

The layer stack shown in the Figure is usually present in the form of a winding wound on an arbor that is built into an aluminum pot.

The parting layer 3 is saturated with an inventive ethylene glycol mixture, whereby dimeric and/or trimeric acids of the product class EMPOL® of the Henkel company were employed. An electrolytic capacitor that comprises a capacitance of 130 mF and has an electrostatic serial resistance of 500 mΩ at a frequency of 120 Hz was capable of being realized with the assistance of this ethylene glycol mixture.

This shows that a higher electrostatic serial resistance need not be accepted given employment of the inventive ethylene glycol mixture, despite the low water content compared to known ethylene glycol mixtures. This derives therefrom that the acids present in the inventive ethylene glycol mixture comprise a high electrical conductivity.

The invention is not limited to the embodiment shown by way of example but is defined in its most general form by claim 1 and claim 4.

1. Ethylene glycol mixture with:
a) 20-70 weight percent ethylene glycol
b) 1-10 weight percent ammonium pentaborate
c) 1-10 weight percent mannitol
d) 0-1.0 weight percent 4-nitro-benzoic acid
e) 0-0.5 weight percent ammonium hypophosphite
f) 3-35 weight percent diethylene glycol monobutyl ether
g) 2-10 weight percent of a mixture of dimeric and trimeric acids.

2. Ethylene glycol mixture according to claim 1 with:
a) 50-60 weight percent ethylene glycol
b) 2-4.5 weight percent ammonium pentaborate
c) 1-4 weight percent mannitol
d) 0.2-0.7 weight percent 4-nitro-benzoic acid
e) 0-0.2 weight percent ammonium hypophosphite
f) 15-22 weight percent diethylene glycol monobutyl ether
g) 3-9 weight percent of a mixture of dimeric and trimeric acids.

3. Ethylene glycol mixture according to claim 1 or 2, whereby the mixture of acids comprises dimeric or trimeric acids from the following list of CAS numbers:
61788-89-4, 68783-41-5, 68937-90-6.

4. Aluminum electrolytic capacitor with a ethylene glycol mixture according to claim 1 through 3 as electrolyte, comprising a layer stack with an anode layer (1) and a cathode layer (2) as well as an intervening parting layer (3) saturated with the electrolyte, whereby the anode layer (1) and the cathode layer (2) respectively comprise an oxide layer (4, 5) at their side facing toward the parting layer (3).

5. Employment of the ethylene glycol mixture according to claim 1 or 2 as electrolyte in an aluminum electrolytic capacitor for voltages >500 V.
